(19) United States
(12) Patent Application Publication
(10) Pub. No.: US 2026/0016764 A1
(43) Pub. Date: Jan. 15, 2026

(54) ELECTRIFICATION DEVICE, PROCESS CARTRIDGE, AND ELECTROPHOTOGRAPHIC IMAGE FORMING APPARATUS

(71) Applicant: CANON KABUSHIKI KAISHA, Tokyo (JP)

(72) Inventors: MASATSUGU HONGO, Shizuoka (JP); YUICHI KIKUCHI, Shizuoka (JP); TAKUMI FURUKAWA, Shizuoka (JP); KENJI TAKASHIMA, Kanagawa (JP); MOTOTERU GOTO, Shizuoka (JP)

(21) Appl. No.: 19/335,233

(22) Filed: Sep. 22, 2025

Related U.S. Application Data
(63) Continuation of application No. PCT/JP2024/011863, filed on Mar. 26, 2024.

(30) Foreign Application Priority Data
Mar. 27, 2023 (JP) 2023-049767

(51) Int. Cl. G03G 5/02; G03G 15/02; G03G 21/18; H05H 1/24

(52) U.S. Cl. CPC G03G 5/0211; G03G 15/0291; G03G 21/1814; H05H 1/2406; G03G 2215/028

(57) ABSTRACT

Provided is an electrification device equipped with a plasma actuator, wherein the plasma actuator: comprises a dielectric body, a first electrode provided on a first surface of the dielectric body, and a second electrode disposed across the dielectric body from the first electrode; by applying alternating-current voltage between the first electrode and the second electrode, generates an induced flow along an exposed portion not covered with the first electrode of the first surface of the dielectric body from an edge portion of the first electrode; and is disposed such that the induced flow is directly supplied to the surface of the body to be electrified, and applies direct-current voltage between the first electrode and the body to be electrified.

### CROSS-REFERENCE TO RELATED APPLICATIONS

This application is a Continuation of International Patent Application No. PCT/JP2024/011863, filed Mar. 26, 2024, which claims the benefit of Japanese Patent Application No. 2023-049767, filed Mar. 27, 2023, both of which are hereby incorporated by reference herein in their entirety.

### BACKGROUND

### Field of the Technology

The present disclosure relates to a charging apparatus, a process cartridge, and an electrophotographic image forming apparatus.

### Description of the Related Art

In electrophotographic image forming apparatuses, a contact charging method using a charging roller is widely used as a method for charging a photosensitive drum. In the contact charging method, a developing agent remaining on the photosensitive drum (also called “residual toner” hereinafter) and the like may adhere to the surface of the charging roller and interfere with stable discharge from the charging roller. To solve such problems with the contact charging method, a non-contact charging method has been proposed, in which the surface of an electrophotographic photosensitive member is charged without bringing the electrophotographic photosensitive member into contact with a member like a charging roller.

Japanese Patent Laid-Open No. H7-084435 discloses a charging apparatus that uses a solid-state discharge element having a dielectric interposed between an induction electrode and a discharge electrode. In this charging apparatus, the induction electrode is provided at a position distanced from a straight line connecting the center of the discharge electrode with the closest position of the uncharged surface. In other words, this document discloses a charging apparatus capable of uniform charging by arranging the induction electrode and the discharge electrode in a non-overlapping manner, and using a solid-state discharge element that suppresses insulation breakdown. Meanwhile, Japanese Patent Laid-Open No. 2006-039288 discloses a charging apparatus that uses a non-contact charging roller. Furthermore, Japanese Patent Laid-Open No. 2003-140438 discloses a charged member apparatus that includes a scorotron-type charger.

### SUMMARY

The inventors of the present disclosure used the charging apparatuses according to Japanese Patent Laid-Open No. H7-084435, Japanese Patent Laid-Open No. 2006-039288, and Japanese Patent Laid-Open No. 2003-140438 in recent electrophotographic processes designed for longer lifespans, and attempted to evaluate the durability thereof with respect to use over longer periods. The results indicate that in some cases, even with non-contact types, contaminants accumulate on the charging member and discharge unevenness arises, which causes the body (e.g., an electrophotographic photosensitive member such as a photosensitive drum) to be charged in a non-uniform manner.

At least one aspect of the present disclosure is directed at providing a charging apparatus capable of stably charging a body to be charged over a long period of time. Additionally, at least one aspect of the present disclosure is directed at providing a process cartridge that contributes to high-quality electrophotographic image formation over a long period of time. Furthermore, at least one aspect of the present disclosure is directed at providing an electrophotographic image forming apparatus capable of forming high-quality electrophotographic images over a long period of time.

At least one aspect of the present disclosure provides a charging apparatus for charging a body to be charged, the charging apparatus comprising: a plasma actuator, wherein the plasma actuator comprises: a dielectric; a first electrode provided on a first surface of the dielectric; and a second electrode disposed with the dielectric interposed between the first electrode and the second electrode, wherein when an AC voltage is applied between the first electrode and the second electrode, the plasma actuator generates an induced flow from an edge of the first electrode along an exposed portion of the first surface of the dielectric which is not covered by the first electrode, the plasma actuator is disposed such that the induced flow is directly supplied to the surface of the body to be charged, and a DC voltage is applied between the first electrode and the body to be charged.

At least one aspect of the present disclosure provides a process cartridge capable of being attached to and removed from a body of an electrophotographic image forming apparatus, the process cartridge comprising the above charging apparatus.

At least one aspect of the present disclosure provides an electrophotographic image forming apparatus comprising the charging apparatus described above.

Features of the present disclosure will become apparent from the following description of embodiments with reference to the attached drawings.

### BRIEF DESCRIPTION OF THE DRAWINGS

FIG. 1 is a schematic diagram illustrating the configuration of a charging apparatus according to at least one aspect of the present disclosure.

FIG. 2 is a schematic diagram illustrating an example of the configuration of a plasma actuator and a charging apparatus.

FIG. 3 is an explanatory diagram illustrating the neutralization of contaminants through induced flow.

FIG. 4 is an explanatory diagram illustrating overlapping of a first electrode and a second electrode.

FIGS. 5A to 5D are explanatory diagrams illustrating the suppression of electrical field concentration through overlapping.

FIGS. 6A to 6C are explanatory diagrams illustrating unevenness in an edge of the first electrode.

FIGS. 7A to 7D are explanatory diagrams illustrating the arrangement of the plasma actuator.

FIG. 8 is a schematic diagram illustrating a positional relationship between a photosensitive drum, a dielectric, and the first electrode.

FIGS. 9A and 9B are schematic diagrams illustrating an example of the configuration of the plasma actuator.

FIG. 10 is a schematic diagram illustrating a process cartridge using the charging apparatus according to the present disclosure.

FIG. 11 is a schematic diagram illustrating an electrophotographic image forming apparatus using the charging apparatus according to the present disclosure.

FIG. 12 is an explanatory diagram illustrating a method for measuring wind speed through PIV.

FIG. 13 is an explanatory diagram illustrating the arrangement of the plasma actuator.

FIG. 14 is an explanatory diagram illustrating the arrangement of a scorotron charger.

### DESCRIPTION OF THE EMBODIMENTS

Hereinafter, embodiments for carrying out this disclosure will be specifically exemplified with reference to the drawings. However, it is to be understood that dimensions, materials, shapes, relative arrangements, and the like of components described in the embodiments are intended to be changed as deemed appropriate in accordance with configurations and various conditions of members to which the disclosure is to be applied. In other words, the scope of this disclosure is not intended to be limited to the embodiments described below.

Additionally, in the present disclosure, the description of “from XX to YY” and “XX to YY” representing a numerical range means a numerical range including the lower limit and the upper limit which are endpoints, unless specified otherwise. When the numerical ranges are described in stages, the upper limits and lower limits of respective numerical ranges can be combined arbitrarily. Also, in the present disclosure, for example, the description such as “at least one selected from the group consisting of XX, YY and ZZ” means any of XX, YY, ZZ, a combination of XX and YY, a combination of XX and ZZ, a combination of YY and ZZ, or a combination of XX, YY and ZZ.

As a result of intensive investigations, the inventors of the present disclosure found that using a plasma actuator as the charging member, and arranging the plasma actuator such that induced flow generated by the discharge is supplied directly to the surface of the body to be charged (e.g., an electrophotographic photosensitive member such as a photosensitive drum), makes it possible to suppress contaminants from jumping and therefore suppress situations where contaminants adhere to the charging member.

In the present disclosure, “contaminant” refers to substances that, assuming the body to be charged is an electrophotographic photosensitive member, remain on the surface of the electrophotographic photosensitive member without being completely transferred, and then jump when toner is transferred to paper or an intermediate transfer member during the transfer process of the electrophotographic image forming process and adhere to the charging member. If the electrophotographic image forming apparatus includes a cleaning member, the “contaminant” includes substances which get past the cleaning member, jump toward the charging member, and adhere thereto. Toner and external additives can therefore be given as examples of “contaminants”.

As a result of these investigations, the inventors inferred that charging members according to Japanese Patent Laid-Open No. H7-084435, Japanese Patent Laid-Open No. 2006-039288, and Japanese Patent Laid-Open No. 2003-140438 experienced image defects due to contaminants adhering thereto for the following reasons, in electrophotographic processes designed for longer lifespans.

The inventors believe that the reason why the non-contact charging members of the electrophotographic photosensitive members according to Japanese Patent Laid-Open No. H7-084435, Japanese Patent Laid-Open No. 2006-039288, and Japanese Patent Laid-Open No. 2003-140438 became contaminated was because the contaminants jumped toward the charging member due to electrostatic force between the charging member and the contaminants. It is necessary for contaminants such as toner and external additives to have a constant charge in order to be properly transferred to the electrophotographic photosensitive member during the development process. Insulative properties are therefore often present. Since the toner and external additives that are not transferred to the paper or the intermediate transfer member and remain on the electrophotographic photosensitive member are affected by rubbing and the like before reaching the charging member, the toner and external additives do not have a significantly positively- or negatively-biased charge in the developer container, but rather have a constant distribution in terms of polarity.

On the other hand, the charging member is a member that applies a voltage to the electrophotographic photosensitive member to produce a discharge, and generates a potential difference between the charging member and the surface of the electrophotographic photosensitive member. As such, because contaminants having the opposite polarity from the charging bias jump toward the charging member due to electrostatic attraction, it is difficult to avoid situations where contaminants adhere to the charging member.

In addition, in the charging member, contaminants adhere strongly due to electrostatic force, and thus once contaminants have adhered, it is difficult to cause the contaminants to return to the electrophotographic photosensitive member. It is generally known that the charging member may therefore have a cleaning member. However, providing the electrophotographic image forming apparatus with a cleaning member for the charging member is not desirable from the perspective of making the electrophotographic image forming apparatus more compact. The inventors therefore recognized that preventing contaminants from jumping to the charging member is an effective way to reduce contaminants adhering to the charging member in non-contact charging processes.

After conducting investigations having obtained this knowledge, the inventors found that with the charging apparatus having the configuration according to the present disclosure, contaminants are unlikely to adhere to a discharge portion of the charging member even with long-term use, and the body to be charged can be stably charged over a longer period of time.

In other words, a charging apparatus according to at least one aspect of the present disclosure includes a plasma actuator. The plasma actuator includes a dielectric, a first electrode provided on a first surface of the dielectric, and a second electrode disposed with the dielectric interposed between the first electrode and the second electrode. When an AC voltage is applied between the first electrode and the second electrode, the plasma actuator generates an induced flow from an edge of the first electrode along an exposed portion of the first surface of the dielectric which is not covered by the first electrode. The plasma actuator is disposed such that the induced flow is directly supplied to the surface of the body to be charged. The charging apparatus applies a DC voltage between the first electrode and the body to be charged.

The charging apparatus of the present disclosure will be described in detail hereinafter.

### Charging Apparatus and Plasma Actuator

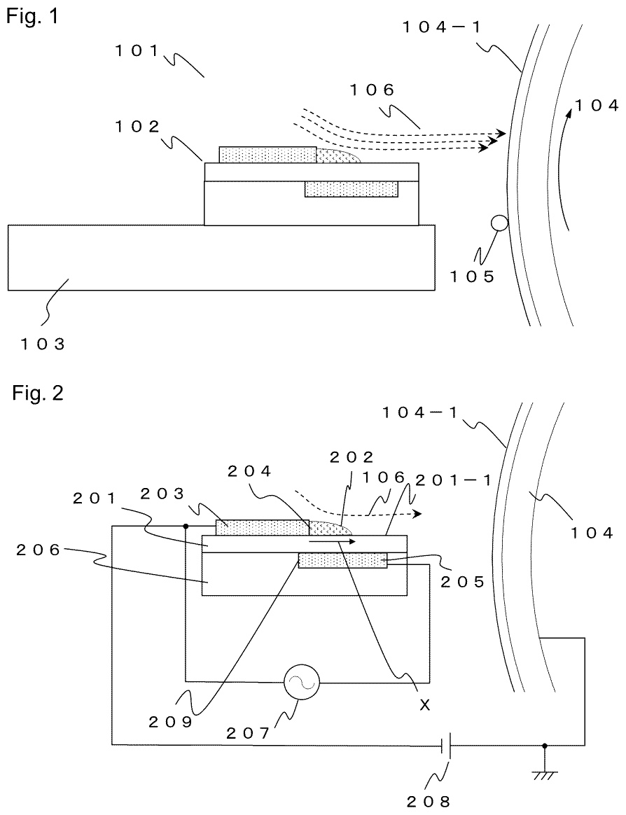

FIG. 1 illustrates a charging apparatus 101 that charges an electrophotographic photosensitive member 104 serving as a body to be charged, according to at least one aspect of the present disclosure. The charging apparatus 101 includes a plasma actuator 102. In FIG. 1, reference sign 105 indicates contaminants (residual toner) remaining on a surface 104-1 of a photosensitive drum serving as the electrophotographic photosensitive member, and reference sign 106 indicates induced flow.

FIG. 2 illustrates the cross-sectional structure of the plasma actuator 102 in at least one aspect, and of the charging apparatus in at least one aspect.

In FIG. 2, the plasma actuator 102 includes a dielectric 201, and a first electrode 203 provided on one surface (also called a “first surface” hereinafter) of the dielectric 201. The plasma actuator 102 includes a second electrode 205 with the dielectric 201 interposed between the first electrode 203 and the second electrode 205. In other words, the second electrode 205 is provided with the dielectric 201 interposed between the first electrode 203 and the second electrode 205. Here, the second electrode 205 is preferably disposed obliquely with a shift across the dielectric 201 to the first electrode 203. Disposing the first electrode 203 and the second electrode 205 shifted obliquely with a shift across the dielectric 201 makes it possible to more reliably supply the induced flow 106 in a desired direction. This makes it possible to further increase the charging efficiency of the body to be charged. Note that the aspect including the second electrode 205 with the dielectric 201 interposed between the first electrode 203 and the second electrode 205 includes the aspect illustrated in FIG. 2 and the aspect illustrated in FIG. 9B. Aspects such as that illustrated in FIG. 9B will be described later.

The plasma actuator 102 may, for example, be provided with the second electrode 205 on a surface on the side opposite from the side on which the first surface is located (also called a “second surface” hereinafter). The plasma actuator 102 is what is known as a dielectric barrier discharge (DBD) plasma actuator (this may be called simply a “DBD-PA” hereinafter).

In FIG. 2, reference sign 206 indicates a dielectric substrate, reference sign 207 indicates an AC power source, reference sign 208 indicates a DC power source, and reference sign 209 indicates an edge of the second electrode.

In the plasma actuator 102, the first electrode 203 and the second electrode 205 are disposed obliquely with a shift across the dielectric 201, for example. When an AC voltage is applied between the electrodes (between both electrodes), plasma 202 moving from the first electrode 203 toward the second electrode 205 is generated. Then, the induced flow 106, which is a jet-like flow caused by the plasma (surface plasma) 202, is induced along an exposed portion (a portion not covered by the first electrode) 201-1 of the first surface of the dielectric 201 from the edge 204 of the first electrode 203.

The plasma actuator 102 is disposed such that the induced flow 106 is directly supplied to the surface 104-1 of the electrophotographic photosensitive member serving as the body to be charged.

That is, according to such an aspect, the induced flow 106 from the plasma actuator 102, which has a charge, is supplied directly to the surface of the electrophotographic photosensitive member.

The induced flow 106 contains positively charged particles, negatively charged particles, and electrically neutral particles produced through ionization resulting from the discharge of the plasma actuator. In the charging apparatus, a DC voltage is applied between the first electrode 203 and the body to be charged 104. For example, a positive or negative DC voltage may be applied between the first electrode 203 and the body to be charged 104.

An electrical field formed by applying a positive DC voltage or a negative DC voltage between the first electrode 203 and the photosensitive drum 104 serving as the body to be charged can preferentially supply the photosensitive drum surface 104-1 with a charge of the same polarity as the DC voltage, of the positive charge or a negative charge produced through ionization resulting from the discharge of the plasma actuator. In other words, superimposing the discharge of the plasma actuator produced by the AC voltage with the DC voltage makes it possible to control the charge supplied to the photosensitive drum 104, the photosensitive drum surface 104-1 can be charged, and contaminants (not shown) can be neutralized or charged. In addition, as a higher DC voltage is applied, a greater charge of the same polarity as the applied voltage is supplied to the photosensitive drum surface 104-1 and the contaminants, which improves the charging and neutralizing performance.

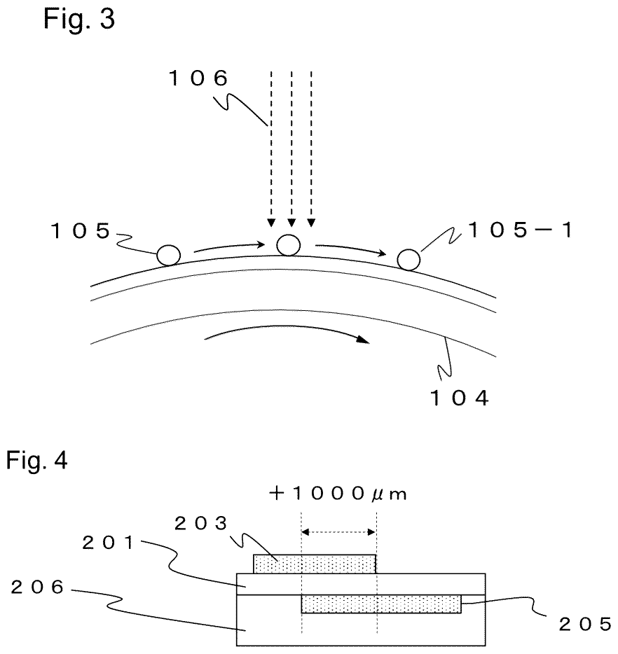

As illustrated in FIG. 3, when the body to be charged is a photosensitive drum, the contaminant 105 charged by the transfer roller to a charge of the opposite polarity from the charging bias is transported in accordance with the rotation of the photosensitive drum 104, and is subjected to the induced flow 106 having a charge of the same polarity as the charging bias. As a result, a contaminant 105-1 subjected to the induced flow can be neutralized or charged to the same polarity as the photosensitive drum 104 by the charge of the same polarity as the charging bias contained in the induced flow. When the contaminant 105 is neutralized or charged to the same polarity as the photosensitive drum 104, the electrostatic attraction between the contaminant and the plasma actuator 102 can be reduced, which makes it possible to suppress situations where contaminants jump to the charging member.

In addition, the induced flow 106 flows in a direction where the contaminants are held against the surface of the photosensitive drum, which also makes it possible to physically suppress situations where the contaminants jump. This also effectively suppresses the adherence of contaminants to the charging apparatus.

As a result, according to the charging apparatus of the present disclosure, it is possible to suppress situations where contaminants jump to the charging member, which is inevitable in non-contact charging, and to suppress situations where contaminants adhere to a discharge portion of the charging member. As a result, high-quality image formation can be performed over a long period of time.

The induced flow 106 flows in a jet-like form, produced by the surface plasma, in a flow direction from the edge 204 of the first electrode 203 along the exposed portion 201-1 of the first surface of the dielectric 201, i.e., flows in a direction from the edge 204 of the first electrode 203 along the exposed portion 201-1 of the first surface of the dielectric. This induced flow is a gas flow at a velocity of from several m/s to several tens of m/s.

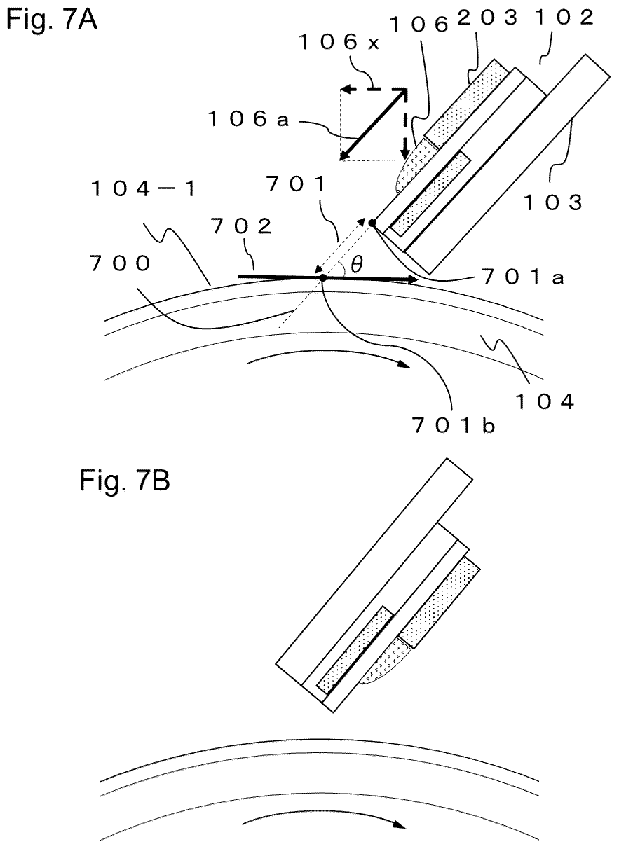

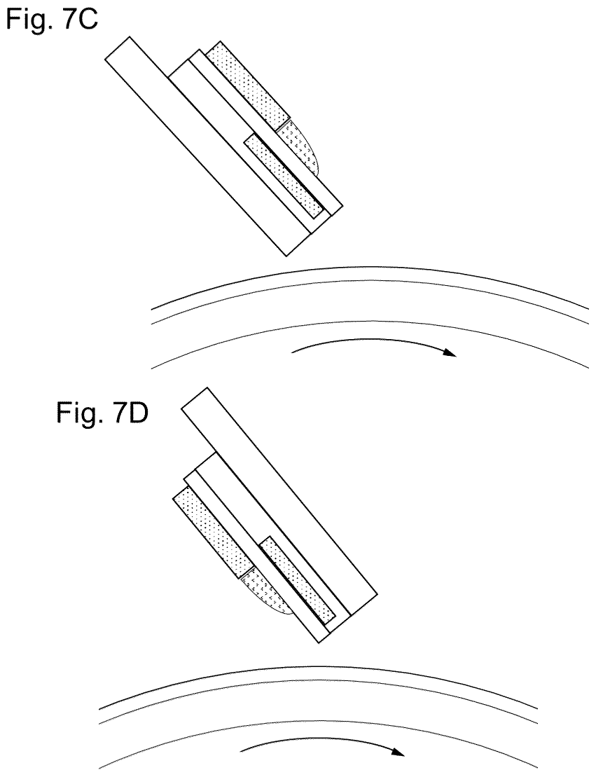

The velocity of the induced flow measured through particle image velocimetry at a position 1.0 mm away from the leading end of the induced flow of the plasma actuator in the supply direction thereof is preferably from 0.10 to 1.00 m/see, more preferably from 0.15 to 1.00 m/see, and even more preferably from 0.20 to 0.40 m/sec. The position 1.0 mm away from the leading end is a position 1.0 mm from a leading end 701a on the second electrode side with respect to the supply direction of the induced flow, in an extension line (line 700) extending from the edge of the first electrode of the plasma actuator in FIG. 7A in the direction along the exposed portion 201-1 of the first surface of the dielectric. Ensuring the velocity is in the above ranges makes it possible to supply a more sufficient induced flow for charging the electrophotographic photosensitive member and neutralizing/charging the contaminants.

It is possible to know that contaminants such as residual toner have been neutralized or charged to the same polarity as the photosensitive drum by, for example, measuring the surface potential of groups of residual toner on the photosensitive drum, the amount of charge thereof, or the like. Specifically, it is possible to know that the residual toner has been neutralized by using, for example, means for quantifying a distribution of the charge amounts of the groups of residual toner (described later). To be more specific, for example, a method can be used which confirms the number percentage of toner particles which had the same polarity as the voltage applied to the transfer member (also called “polarity A” hereinafter) before the residual toner was irradiated with the induced flow 106 and which then changed to the polarity opposite to the polarity A after the induced flow irradiation.

The amount of the residual toner when confirming the change in the polarity may be measured as the change in the charge polarity of the residual toner by the plasma actuator under transfer process conditions in which a fog value, obtained by a measurement method such as that described below, is 5%. Specifically, the fog value can be measured as follows, for example. First, printing operations are stopped while a solid black image is being printed, and residual toner adhering between the transfer member contact region on the surface of the photosensitive drum and the charging member contact region is removed with tape (model CT18; manufactured by Nichiban Co., Ltd.). The reflectance was then measured using a reflectance densitometer (model TC-6DS/A; manufactured by Tokyo Denshoku Co., Ltd.), and the amount of decrease (%) in the reflectance relative to the reflectance of the tape was measured and taken as the fog value.

Furthermore, for groups of residual toner under transfer process conditions that result in the fog value described above, the number percentage of groups of toner that changed from the same polarity as the voltage applied to the transfer member to the opposite polarity is measured before and after irradiation by the plasma actuator. This number percentage is based on the number of toner particles of the same polarity as the voltage applied to the transfer member before irradiation. A rate of change Δ after irradiation (described later) is preferably at least 50%. A rate of change Δ of from 80% to 100% is even more preferable. Having the rate of change Δ be within this range makes it possible to suppress electrostatic attraction with the photosensitive drum, which in turn makes it possible to improve the cleaning performance.

### Electrode Arrangement

FIG. 4 is an explanatory diagram illustrating overlapping of the first electrode 203 and the second electrode 205 of the plasma actuator, which is the charging member. In FIG. 4, the first electrode 203 and the second electrode 205 are disposed obliquely with a shift across the dielectric 201. Here, when the plasma actuator is viewed in perspective from the first surface side, it is preferable that an overlapping portion where at least a portion of the first electrode and the second electrode overlap is present. In other words, regarding the first electrode 203 and the second electrode 205 disposed obliquely with a shift across the dielectric 201, when the dielectric is viewed in perspective from the surface side of the first electrode, the edge of the first electrode is preferably present in an area where the second electrode is formed. In other words, the first electrode and the second electrode are preferably provided such that the first electrode and the second electrode overlap, with the dielectric interposed therebetween.

By arranging the first electrode and the second electrode so as to overlap with the dielectric interposed therebetween, the distance between the electrodes is minimized and the electrical field strength is maximized, which makes it possible to generate a strong induced flow. In this case, it is preferable that at the part where the first electrode and the second electrode overlap with the dielectric interposed therebetween, insulation breakdown does not occur when voltage is applied.

In addition, when the edge of the second electrode is exposed, plasma is also produced from the edge of the second electrode, and an induced flow in the direction opposite from the direction of the induced flow 106 coming from the first electrode may be produced. It is preferable that an induced flow is not brown in areas other than the surface of the photosensitive drum. Accordingly, it is preferable not to produce an induced flow from the second electrode. Therefore, the second electrode 205 is preferably covered with a dielectric as indicated by the dielectric substrate 206 illustrated in FIGS. 2 and 9, or embedded in the dielectric 201 to prevent plasma from being produced from the edge of the second electrode.

From the viewpoint of uniformly neutralizing and charging contaminants, it is preferable that the induced flow be produced from one side of the first electrode when the plasma actuator is viewed from above, from the side of the first electrode. For example, it is preferable to generate an induced flow in one direction, from one side of the first electrode facing the surface of the photosensitive member toward the surface of the photosensitive member. Other sides of the first electrode may be covered with a dielectric such that no induced flow occurs from sides of the first electrode other than the one side.

### Overlap

FIG. 4 is an explanatory diagram (a cross-sectional view) illustrating overlapping of the first electrode 203 and the second electrode 205 of the plasma actuator.

The length of the overlapping portion of the edge of the first electrode and the edge of the second electrode is defined as a length A, and the overlapping length is defined as positive. In other words, when the plasma actuator is viewed in perspective from the first surface side, it is preferable that an overlapping portion where at least a portion of the first electrode and the second electrode overlap is present, and that the length A between the edge of the first electrode and the edge of the second electrode forming the overlapping portion be from 0 to 1200 μm, more preferably from 80 to 1000 μm, even more preferably from 100 to 1000 μm, and even more preferably from 400 to 1000 μm.

By causing the first electrode and the second electrode to overlap, an effect of suppressing electrical field concentration caused by the electrode edge having a protruding shape (described later) can be obtained, which makes it possible to suppress streaks in images caused by uneven discharges as well as uneven adherence of contaminants caused by uneven induced flow.

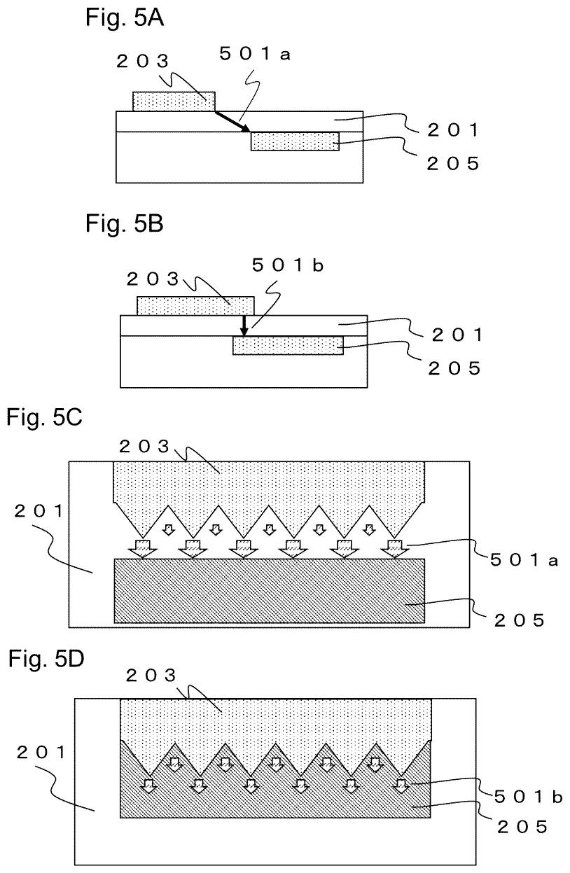

The protruding shape of the edge of the electrode will be described next. FIGS. 5A to 5D illustrate a cross-sectional view and an overhead view of the plasma actuator. As illustrated in FIG. 5A, when the first electrode and the second electrode are separated, do not overlap, and the edge of the first electrode has a protruded portion, an electrical field may concentrate at the apex of the protruded portion of the edge of the first electrode, and unevenness in the discharge and unevenness in the induced flow may arise in the longitudinal direction (501a), as illustrated in FIG. 5C. On the other hand, when the first electrode and the second electrode overlap as illustrated in FIG. 5B, the strength of the electrical field formed between the two electrodes is controlled by the thickness of the dielectric layer. As a result, uneven discharge in the longitudinal direction can be alleviated (501b), as illustrated in FIG. 5D. Furthermore, because local electrical field concentration on the protruded portion can be suppressed, insulation breakdown can be suppressed even when the distance between the two electrodes is small. Note that when the electrode has a protruding shape, the length A is a length between the edge of the first electrode closest to the second electrode side and the edge of the second electrode closest to the first electrode side.

### Electrode Thickness

The thicknesses of both the first electrode and the second electrode are not particularly limited, and can be from 10 μm to 1000 μm. A thickness of at least 10 μm ensures a low resistance and makes plasma easier to produce. A thickness of not more than 1,000 μm makes it easier to produce plasma, because electrical field concentration is more likely to arise.

### Electrode Material

The material constituting the first electrode and the second electrode is not particularly limited as long as it is a material having good conductivity. For example, metals such as copper, aluminum, stainless steel, gold, silver, platinum, and the like, materials having those plated or deposited thereon, conductive carbon materials such as carbon black, graphite, carbon nanotubes, and the like, composite materials mixed with resins, and the like can be used. The material constituting the first electrode and the material constituting the second electrode may be the same or different.

Among these, from the viewpoint of avoiding corrosion in the electrodes and achieving uniform discharge, the material constituting the first electrode is preferably aluminum, stainless steel, or silver. For the same reason, the material constituting the second electrode is preferably aluminum, stainless steel, or silver.

### Electrode Shapes

The shapes of the first electrode and the second electrode can be flat plates, wire-shaped, needle-shaped, or the like, and are not particularly limited. The first electrode preferably has a flat plate shape. Likewise, the second electrode preferably has a flat plate shape. When at least one of the first electrode and the second electrode is a flat plate, the aspect ratio (length of the long side/length of the short side) of the flat plate is preferably at least 2.

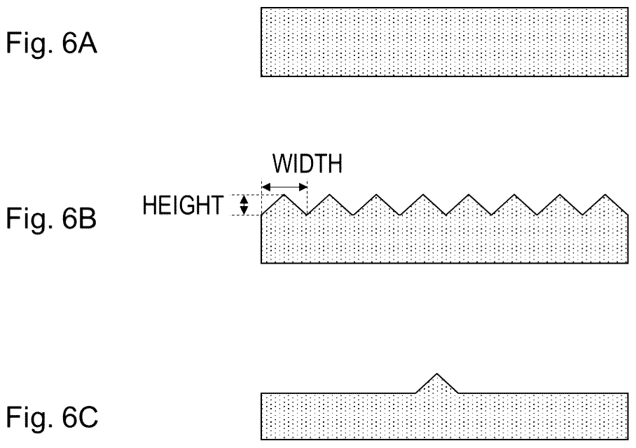

FIGS. 6A to 6C are schematic diagrams illustrating non-limiting examples of electrode shapes.

The edge of the first electrode and the edge of the second electrode are preferably linear or substantially linear. A “substantially linear” shape is not limited to a perfectly linear shape, and some unevenness or the like can be tolerated as long as the discharge is uniform and the electrical field concentration can be suppressed, for example. Specifically, as illustrated in FIG. 6A, a linear shape without unevenness is preferable. Because the edges of the electrodes are linear, the discharge becomes uniform, and the charge can be supplied uniformly over the longitudinal direction.

When the edge has a protruded portion, the discharge becomes non-uniform over the longitudinal direction, and the surface potential on the photosensitive drum becomes non-uniform. This makes streaks more likely to occur in images. Accordingly, the edge of the first electrode may have a protruded portion, and the edge of the second electrode may have a protruded portion, but the shape of the protruded portion is preferably a shape that does not cause image defects even if the discharge becomes non-uniform.

An aspect in which the edge has at least one protruded portion can be given as an example of the shape of the edge (FIG. 6C). From the viewpoint of strengthening the induced flow, it is preferable that the edge have a plurality of protruded portions, and the protruded portions are preferably arranged with regularity. The edge may have protruded portions intermittently, but it is preferable that the protruded portions be continuous (FIG. 6B).

The maximum height of the protruded portion is not particularly limited, but it is preferably not more than 100 μm, more preferably not more than 70 μm, even more preferably not more than 60 μm, and particularly preferably not more than 40 μm. The lower limit is not particularly limited, but may be at least 1 μm, at least 5 μm, or at least 10 μm. Preferred examples include from 1 to 100 μm, from 1 to 70 μm, from 5 to 60 μm, and from 10 to 40 μm. The height of the protruded portion can also be referred to as a length in the direction of the length A.

The width of the protruded portion is not particularly limited, but is preferably not more than 110 μm, more preferably not more than 95 μm, even more preferably not more than 60 μm, and particularly preferably not more than 40 μm. The lower limit is not particularly limited, but may be at least 1 μm, at least 5 μm, or at least 10 μm. Preferred examples include from 1 to 110 μm, from 1 to 95 μm, from 5 to 60 μm, and from 10 to 40 μm. The width of the protruded portion can also be referred to as a length perpendicular to the direction of the length A and along the surface of the dielectric.

To make the height and width of the largest protruded portion smaller within the above range, the edge of the first electrode may be formed in a shape having as little unevenness as possible. For example, when an electrode is formed using masking, such as when performing applying liquid such as screen printing, or metal vapor deposition, a method can be used in which printing is performed on the surface of the dielectric on which the electrodes are formed, using a masking member having an edge shape cut by polishing or a sharp blade such that unevenness in the longitudinal direction is not present. In addition, a metal sheet having an edge shape cut by polishing or a sharp blade, a razor, or the like can be used to ensure unevenness in the longitudinal direction is not present.

The shape of the protruded portion is not particularly limited, and a serrated shape such as that illustrated in FIG. 6B can be given as an example; a triangular shape, a substantially triangular shape, an arc shape, an elliptical arc shape, a substantially arc-like shape, a sine wave shape, a trapezoidal shape, a substantially trapezoidal shape, a rectangular shape, a substantially rectangular shape, or the like can also be given as examples.

As also described above, the electrical field concentration produced by the shape of the protruded portion of the edge of the first electrode can be reduced by controlling the amount of overlap between the first electrode and the second electrode.

The method for forming the first electrode and the second electrode is not particularly limited, and methods such as fixing a metal plate to the dielectric, vapor deposition, screen printing, and the like can be given as examples. To produce a stable discharge and supply a charge to the electrophotographic photosensitive member uniformly over a long period of time, it is preferable to use a conductive tape having an edge formed with a consistent shape, or a metal plate having a tip polished to a blade-like shape, as the electrode.

Methods for measuring the shape of the electrode include a method of observing the plasma actuator from the first surface side using an optical microscope, a laser microscope, an electron microscope, a digital camera, visual inspection, a loupe, or the like. To measure the shape more accurately, it is preferable to use a laser microscope or an optical microscope having a dimensional measurement function.

Specifically, the height and width of the protruded portion at the edges of the first electrode and the second electrode can be calculated using the following procedure.

The height and width of the protruded portion can be obtained as follows, for example. First, a step formed by the first electrode and the dielectric layer is photographed using an optical microscope, a laser microscope, a confocal microscope, or the like. Specifically, a laser microscope (model Color 3D Laser Microscope VK-8700, manufactured by Keyence Corporation) is used to observe and confirm the longitudinal direction within a field of view of 1000 μm vertically and 1000 μm horizontally. Two-dimensional image data is obtained by scanning a laser in the X-Y plane within the field of view, and three-dimensional image data is then obtained by repeating the scanning in the Z direction every 0.2 μm in the height direction.

The 3D data is obtained across the entire first electrode in the longitudinal direction, and a length measurement function of analysis software included with the laser microscope is then used to calculate the height and width as illustrated in FIG. 6B. Because the height of the protruded portion is more sensitive to electrical field strength than the width, the protruded portion having the greatest height among those measured is designated as the largest protruded portion.

### Applied Voltage

The voltage of the AC voltage applied between the first electrode 203 and the second electrode 205 of the plasma actuator is not particularly limited as long as the plasma actuator can be caused to generate plasma. It is preferable to make the voltage a pulsed voltage.

Furthermore, the amplitude of the voltage can be from 1 kV to 100 kV, and more preferably from 1 kV to 10 kV. Furthermore, the frequency of the voltage is preferably at least 1 kHz, and more preferably from 5 kHz to 20 KHz.

The waveform of the AC voltage is not particularly limited, and can be a sine wave, a square wave, a triangular wave, or the like, but from the perspective of the speed of the rise in voltage, a square wave is preferable.

The duty ratio of the voltage can also be selected as appropriate, but a fast voltage rise is preferable. Preferably, a voltage is applied such that the rise of the voltage from the bottom to the peak of the wavelength amplitude is at least 4,000,000 V/sec.

Furthermore, the amplitude of the voltage applied between the first electrode 203 and the second electrode 205, divided by the film thickness of the dielectric 201 (voltage/film thickness), is preferably at least 10 kV/mm.

### DC Voltage

An induced flow having a charge with a polarity biased toward the opposite polarity component of the charge polarity of the contaminants can be supplied by applying a DC voltage between the first electrode 203 of the plasma actuator and the electrophotographic photosensitive member 104 serving as the body to be charged.

The DC voltage is not particularly limited as long as the charge in the induced flow 106 can be supplied to the surface 104-1 of the body to be charged in a manner that prioritizes the charge of the same polarity as the DC voltage. The DC voltage is set as appropriate to adjust the amount of charge on the electrophotographic photosensitive member 104 serving as the body to be charged and on the contaminant 105 remaining on the surface of the electrophotographic photosensitive member. From the viewpoint of controlling the amount of charge on the photosensitive drum and the contaminants, it is preferable that the DC voltage be from +200 V to +1500 V, from −1500 V to −200 V, or the like. More preferably, the voltage range is set to from +400 V to +1200 V, from −1200 V to −400 V, or the like.

In addition, the greater the DC voltage applied is, the stronger the electrical field formed between the first electrode and the electrophotographic photosensitive member serving as the body to be charged becomes, and thus more charge is supplied to the surface of the electrophotographic photosensitive member. Accordingly, the charging performance with respect to the electrophotographic photosensitive member and the charging/neutralization performance with respect to contaminants remaining on the surface of the electrophotographic photosensitive member are improved. The DC voltage increases the flow rate of the induced flow, which improves the effect of physically suppressing the jumping of contaminants. In other words, the greater the DC voltage applied is, the easier it becomes to achieve high-quality image formation over a long period of time.

By applying the DC voltage, the plasma actuator can also be used as a charging apparatus. In other words, the charging apparatus includes at least the plasma actuator. Then, a DC voltage is applied between the first electrode of the plasma actuator and the body to be charged. Such a charging apparatus can be used as a charging apparatus for an electrophotographic photosensitive member in an electrophotographic process, which makes it possible to omit a charging apparatus such as a contact-type charging roller.

### Dielectric

The dielectric is not particularly limited as long as it is a highly electrically insulative material. For example, a resin such as polyurethane resin, polyimide, polyester, fluorine resin, silicone resin, acrylic resin, phenolic resin, or the like, glass, ceramics, composite materials in which such resins are intermixed, and the like can be used. The dielectric is preferably a polyurethane resin, silicone resin, polyimide, or glass. For example, using a material such as silicone resin, which has a high volume resistivity, low chemical structural non-uniformities or crystalline interfaces, low charge bias, and a low dielectric constant, makes it possible to suppress insulation breakdown between the first electrode and the second electrode, and is therefore preferable.

In addition, in plasma actuators, the shorter the shortest distance between the first electrode and the second electrode is, the easier it is to generate plasma. Accordingly, the thickness of the dielectric is not particularly limited as long as it is within a range in which electrical insulation breakdown does not occur, but thinner is more preferable. For example, the dielectric is preferably from 10 μm to 1000 μm, and more preferably from 10 μm to 200 μm.

In addition, the thickness of the dielectric need not be uniform. For example, the thickness of the dielectric on a first edge side may be from 10 μm to 1000 μm, and the thickness of the dielectric on a second edge side may be 1 to 5 mm. The thickness of the dielectric on the first edge side is preferably from 10 μm to 200 μm.

The shape of the dielectric is not particularly limited as long as the dielectric can be used as a dielectric for the plasma actuator, but the dielectric may be sheet-shaped or flat plate-shaped, for example.

### Arrangement of Plasma Actuator and Photosensitive Drum

The plasma actuator 102 that generates the induced flow is arranged such that the induced flow 106 is directly supplied to the surface 104-1 of the electrophotographic photosensitive member in order to increase the charging efficiency in the surface region of the body to be charged.

For example, as illustrated in FIG. 7A, the body to be charged may be disposed such that the surface 104-1 thereof is included on an extension line extending in a direction along the exposed portion of the first surface of the dielectric from the edge of the first electrode of the plasma actuator 102.

When the charging/neutralization of contaminants by the induced flow 106 of the plasma actuator 102 is insufficient, and the physical force of the induced flow is unable to suppress the jumping of the contaminants, the contaminants may jump toward the first electrode 203 of the plasma actuator 102. Accordingly, in a configuration in which the charging apparatus has a base material and the plasma actuator is disposed on the surface of the base material, it is preferable that the base material be disposed between the plasma actuator and the surface of the body to be charged such that contaminants do not easily jump to the first electrode. For example, as illustrated in FIGS. 7A and 7C, a base material 103 is preferably disposed between the first electrode 203 and the electrophotographic photosensitive member 104 serving as the body to be charged. In addition, the base material 103 is preferably disposed between the plasma actuator 102 and the electrophotographic photosensitive member 104 serving as the body to be charged. The base material will be described later.

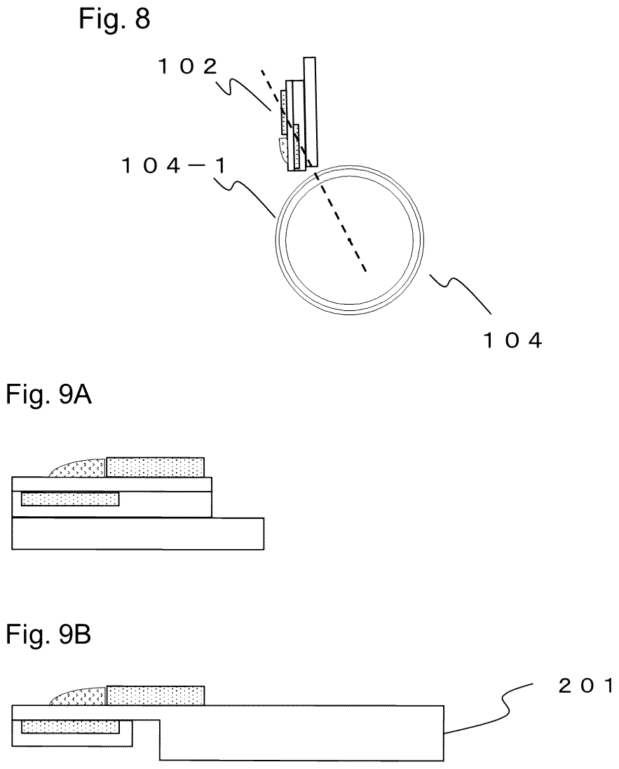

Specifically, when the body to be charged is an electrophotographic photosensitive member, it is preferable that, when a straight line is drawn from the center of an axis of rotation of the electrophotographic photosensitive member toward the center of the first electrode, the straight line intersects the surface of the electrophotographic photosensitive member, the dielectric, and the first electrode in that order, as illustrated in FIG. 8.

On the other hand, as illustrated in FIGS. 7B and 7D, the first electrode 203 may be disposed between the base material 103 and the electrophotographic photosensitive member 104, and the plasma actuator 102 may be disposed between the base material 103 and the electrophotographic photosensitive member 104. By using such an arrangement, air flow within the housing of the electrophotographic apparatus is blocked by the base material, making it possible to suppress the effect of the air flow on the induced flow generated by the plasma actuator. As a result, the induced flow generated by the plasma actuator reaches the surface of the photosensitive drum without being weakened by the air flow, which makes it possible to more effectively charge or neutralize the contaminants.

### Distance Between Plasma Actuator and Photosensitive Drum

Furthermore, to supply the charge in the induced flow more effectively to the surface of the body to be charged, it is preferable that the distance between the plasma actuator and the body to be charged be short, within a range where the discharge from the first electrode of the plasma actuator does not reach the body to be charged directly. In one example, these elements are preferably disposed such that in FIG. 7A, a distance 701 between the leading end of the plasma actuator 102 on the second electrode side thereof, and a point 701b at which an extension line (a line 700) extending from the edge of the first electrode of the plasma actuator 102 in the direction along the exposed portion 201-1 of the first surface of the dielectric intersects the surface of the electrophotographic photosensitive member serving as the body to be charged, is from 1 mm to 20 mm (more preferably from 1 mm to 10 mm, and even more preferably from 1 mm to 5 mm).

Orientation of Plasma Actuator Relative to Direction of Rotation of Photosensitive Drum

In a charging apparatus, the direction of flow of the induced flow of the plasma actuator is not particularly limited as long as the induced flow is supplied directly to the surface of the body to be charged.

The following is a preferred configuration for more effectively achieving the effects of the present disclosure in cases where the body to be charged is an electrophotographic photosensitive member.

As illustrated in FIG. 7A, the extension line 700 from the edge of the first electrode in the direction along the exposed portion of the first surface of the dielectric intersects the surface of the electrophotographic photosensitive member at the point 701b. A velocity vector in the direction of rotation of the electrophotographic photosensitive member on the tangent to the surface of the electrophotographic photosensitive member at point 701b is taken as a tangent vector 702.

When a flow direction vector 106a of the induced flow 106 supplied from the plasma actuator 102 is decomposed, it is preferable that the flow direction vector have a direction component 106x that is parallel to the tangent vector 702 and facing opposite direction from the tangent vector 702 (hereinafter, an arrangement of the plasma actuator in which the direction component 106x is parallel to the tangent vector and facing opposite direction from the tangent vector 702 will be called “counter”, and an arrangement in which the direction component 106x is parallel to the tangent vector and facing the same direction as the tangent vector 702 will be called “with”).

When the flow direction of the induced flow is in the above direction, the relative velocity of the induced flow with respect to the electrophotographic photosensitive member increases, and a stronger flow can be imparted on the contaminants remaining on the surface of the electrophotographic photosensitive member. As a result, the contaminants can be rolled on the surface of the photosensitive drum, the electrophotographic photosensitive member can be charged more effectively, and the contaminants can be charged or neutralized more effectively.

In addition, when the flow direction vector 106a is decomposed, the flow direction vector 106a may have a direction component that is parallel to the tangent vector 702 and facing the same direction as the tangent vector 702 (“with” mentioned above). In such an aspect, the induced flow is less likely to be disturbed by the rotation of the electrophotographic photosensitive member, and the surface of the photosensitive drum and the contaminants can be brought into contact with the induced flow for a longer period of time. As a result, the electrophotographic photosensitive member can be charged more effectively, and the contaminants can be neutralized and charged more effectively.

### Angles

Residual toner, which is an example of a contaminant, has a shape that is close to a perfect sphere, and it was therefore found that there is a suitable angle for more effectively supplying the induced flow into the gap between the contaminant and the surface of the electrophotographic photosensitive member serving as the body to be charged. By supplying the induced flow into the gap between the surface of the electrophotographic photosensitive member and the contaminant, the contaminant on the surface of the electrophotographic photosensitive member is caused to roll, which makes it easier to charge or neutralize the entire surface of the contaminant. In addition, the surface of the electrophotographic photosensitive member covered with the contaminant also becomes easier to charge.

In other words, the narrow angle formed between the extension line extending from the edge of the first electrode of the plasma actuator in the direction along the exposed portion 201-1 of the first surface of the dielectric and the tangent vector 702 is defined as a narrow angle θ. The narrow angle θ is preferably from 0° to 90°, more preferably from 0° to 80°, and even more preferably from 10° to 45°.

Here, the narrow angle that the extension line forms with the tangent vector 702 can be said to be the narrow angle that the extension line forms with the tangent line relative to the surface of the electrophotographic photosensitive member at the point 701b.

### Base Material

The charging apparatus preferably includes a base material. The plasma actuator can be mounted on the base material. In other words, the plasma actuator may be disposed on the surface of the base material.

The base material is not particularly limited, and the cross-sectional shape, width, thickness, material, and the like are also not particularly limited. For example, a base material on which the plasma actuator can be mounted can be given as an example.

The base material is preferably a material that does not deform under its own weight, such as metal, ceramics, a resin such as ABS resin, or the like. The base material is more preferably a material that is highly insulative such that electric charges do not leak from the electrode of the plasma actuator to the outside. The thickness of the base material is preferably a thickness at which the base material does not deform under its own weight. In other words, the material of the base material is preferably a resin, and more preferably an ABS resin.

The thickness of the base material is preferably a thickness at which no charge leaks from the electrode of the plasma actuator to the outside.

In addition, the plasma actuator may be mounted using a frame body of the process cartridge, a main body, or the like as the base material.

The configuration may also be such that the dielectric of the plasma actuator is used as the base material, as illustrated in FIG. 9B. In the plasma actuator in FIG. 9B, the dielectric has a segment interposed between the first electrode and the second electrode, i.e., the plasma actuator includes a second electrode, with the dielectric interposed between the second electrode and the first electrode.

### Process Cartridge

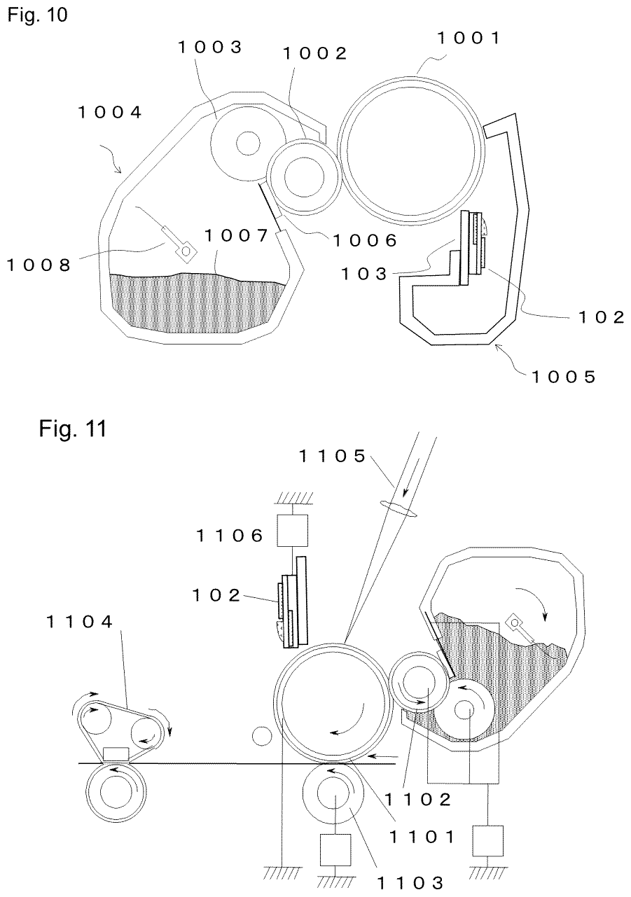

FIG. 10 is a schematic cross-sectional view of a process cartridge including the charging apparatus according to the present disclosure.

The process cartridge includes the charging apparatus of the present disclosure and at least one apparatus used in an electrophotographic process. A developing apparatus can be given as an example of the at least one apparatus used in the electrophotographic process. In other words, it is preferable that the developing apparatus and the charging apparatus be provided in an integrated manner. The process cartridge is preferably configured to be removable from the main body of the electrophotographic apparatus. The process cartridge can be an electrophotographic process cartridge.

The developing apparatus integrates at least a developing roller 1002 and a toner container 1004, and may, as necessary, include at least one element selected from a group consisting of a photosensitive drum 1001, a toner supply roller 1003, toner 1007, a developing blade 1006, and an agitating blade 1008.

The charging apparatus includes at least the plasma actuator 102. A voltage is applied to each of the plasma actuator 102, the photosensitive drum 1001, the developing roller 1002, the toner supply roller 1003, and the developing blade 1006.

### Electrophotographic Apparatus

FIG. 11 is a schematic diagram illustrating an electrophotographic image forming apparatus using the charging apparatus according to the present disclosure.

This electrophotographic image forming apparatus is equipped with the charging apparatus of the present disclosure. The charging apparatus includes the plasma actuator 102.

The electrophotographic image forming apparatus can be constituted by an electrophotographic photosensitive member such as a photosensitive drum; a charging apparatus that charges the photosensitive drum; a latent image forming apparatus that forms an electrostatic latent image by exposing the electrophotographic photosensitive member; a developing apparatus that develops the electrostatic latent image as a toner image; a transfer apparatus that transfers a toner image to a transfer material; a fixing apparatus that fixes the toner image to the transfer material; and the like.

An electrophotographic photosensitive member 1101, such as a photosensitive drum, is a rotary drum, and preferably has a photosensitive layer on a conductive base member. The electrophotographic photosensitive member 1101 is rotationally driven at a predetermined circumferential speed (process speed) in the direction of the arrow. The plasma actuator 102 charges the electrophotographic photosensitive member 1101 to a predetermined potential by using a charging power supply 1106 or the like, for example, to apply an AC voltage and a DC voltage. For example, an exposure device such as a laser beam scanner can be used as the latent image forming apparatus (not shown) that forms an electrostatic latent image on the electrophotographic photosensitive member 1101. An electrostatic latent image is formed by irradiating the uniformly charged electrophotographic photosensitive member 1101 with exposure light 1105 corresponding to image information.

The developing apparatus includes a developing sleeve or a developing roller 1102 disposed near or in contact with the electrophotographic photosensitive member 1101. The developing apparatus forms a toner image by developing the electrostatic latent image through inverse development using toner electrostatically processed to the same polarity as the charge polarity of the electrophotographic photosensitive member 1101.

The transfer apparatus preferably includes a contact-type transfer roller 1103. The transfer apparatus transfers the toner image from the electrophotographic photosensitive member 1101 to a transfer material such as plain paper. The transfer material is conveyed by a sheet feed system (not shown) having a conveyance member.

The toner image transferred to the transfer material is fixed to the transfer material by passing between a fixing belt 1104 heated by a heating apparatus (not shown) and a roller disposed opposite the fixing belt.

### EXAMPLES

The present disclosure will be described in greater detail below using examples and comparative examples. However, aspects of the present disclosure are not limited thereto.

### Example 1

### Preparation of Plasma Actuator

An aluminum foil 2.5 mm high, 300 mm wide, and 100 μm thick was cut out with a sharp blade and affixed with adhesive tape to a first surface of silicone resin (5 mm high, 300 mm wide, and 150 μm thick) serving as the dielectric, to form the first electrode. Additionally, an aluminum foil 2 mm high, 300 mm wide, and 100 μm thick was affixed with adhesive tape to a second surface of silicone resin on the side opposite from the first surface, so as to be located oblique to the aluminum foil affixed to the first surface, to form the second electrode. Furthermore, the second surface including the second electrode was covered with polyimide tape. Through this, a plasma actuator 1 was prepared such that the first electrode and the second electrode overlapped across a width of 500 μm with the dielectric (the silicone resin) interposed therebetween. Note that the first electrode and the second electrode were provided with wires such that a voltage could be applied thereto.

When the protruded portions on the edge of the first electrode were measured across the entire longitudinal direction using a laser microscope, the height of the largest protruded portion was 20 μm, and the width was 22 μm.

### 2. Evaluating Properties

### 2-1. Induced Flow Velocity

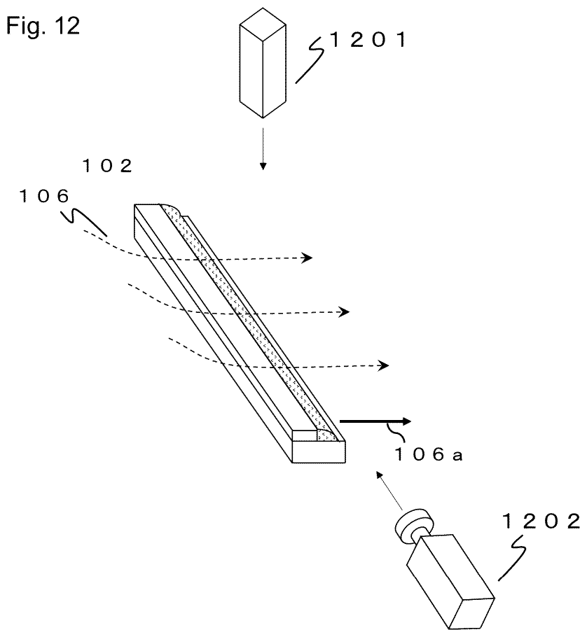

Next, the velocity of the induced flow generated from the plasma actuator was calculated using Particle Image Velocimetry (PIV). FIG. 12 is a schematic diagram of the PIV measurement.

PIV measurement is a method in which oil mist injected on the upstream side of a wind tunnel is made visible using a PIV laser (Kato Koken, G450, 450 mW) 1201 installed downstream from the measurement area and photographed using a USB high-speed camera (Kato Koken, k4) 1202 installed above the measurement area.

The prepared plasma actuator 102 was placed in oil mist, and a square wave having an amplitude of 3 kVpp and a frequency of 12 kHz was applied between the first electrode and the second electrode, and a DC voltage of −600 V was applied between the first electrode and a ground electrode of the electrophotographic apparatus to generate the induced flow 106. The above photography was then performed. The laser output was set to 450 mW, the camera exposure to F2.8, the shutter speed to 1/800, and the FPS to 800. The captured images were analyzed using PIV analysis software (Flow-Expert 64 ver. 1.3.3) to analyze the velocity of oil mist per unit of time and obtain a flow velocity distribution of the induced flow.

Specifically, among the velocity vectors measured in a range of 0.2 mm×1.0 mm in an area 1.0 mm away from the position of the leading end of the plasma actuator, the average flow velocity of the components parallel to the direction of the flow direction vector 106a of induced flow 106 was taken as the induced flow velocity.

In this example, the induced flow velocity was 0.29 m/sec.

### 2-2. Discharge Stability Evaluation

The following evaluations were conducted to confirm the discharge stability of the plasma actuator 1.

First, a laser printer (model Laser Jet Pro M203dw, manufactured by HP) was prepared as an electrophotographic image forming apparatus and modified such that a predetermined voltage could be applied thereto.

The configuration was such that the first electrode and second electrode of the plasma actuator were connected to conductive wires, and a voltage was applied to generate an induced flow. Specifically, the apparatus was modified such that an AC voltage from an AC power source was applied between the first electrode and the second electrode, and a DC voltage was applied between the first electrode and the ground electrode of the electrophotographic apparatus.

Next, an ABS resin sheet (30 mm high, 300 mm wide, and 1 mm thick) was prepared as the base material for mounting the prepared plasma actuator 1. Next, the prepared plasma actuator 1 was attached to one surface of the ABS resin sheet. Specifically, the side on which the polyimide tape covers the second electrode of the plasma actuator was attached and fixed. Next, the ABS resin sheet with the plasma actuator 1 attached thereto was affixed to the process cartridge in a state in which the charging roller was removed. At this time, when a straight line is drawn from the center of the axis of rotation of the photosensitive drum toward the center of the first electrode, the straight line intersects the surface of the photosensitive drum, the dielectric, and the first electrode in that order. In addition, the plasma actuator was affixed so that the plasma actuator was arranged counter. In addition, the distance (701 in FIG. 7A) between the leading end of the second electrode side of the plasma actuator, and the point where the extension line from the edge of the first electrode in the direction along the exposed portion of the first surface of the dielectric intersects the surface of the photosensitive drum, was 2 mm, and narrow angle θ (FIG. 7A), which is the angle formed by the extension line in the direction along the exposed portion of the first surface of the dielectric and the tangent vector, was 30°.

Next, the electrophotographic image forming apparatus and the process cartridge with the plasma actuator 1 attached were left in an environment of 18° C./30% RH for 48 hours for acclimation to the evaluation environment.

The process cartridge left in the stated environment was installed in the laser printer. Then, in the same environment, a square wave having an amplitude of 3 kVpp and a frequency of 12 kHz was applied between the first electrode and the second electrode, a DC voltage of −600 V was applied between the first electrode and the ground electrode of the electrophotographic apparatus, and a halftone image (an image with horizontal lines 1 dot wide and 2 dots apart in the direction perpendicular to the direction of rotation of the photosensitive drum) was output. This halftone was observed both by eye and under a microscope, and vertical streaks were evaluated according to the following criteria. In this example, the rank was rank A. This favorable evaluation indicates that the plasma actuator has high discharge stability.

### Evaluation of Vertical Streaks in Halftone Image

Rank A: No vertical streaks were observed in the halftone image both when inspecting by eye and when observing through a microscope.

Rank B: No vertical streaks were observed in the halftone image when inspecting by eye, but were visible when observed under a microscope.

Rank C: Vertical streak-like images were observed in a part of the halftone image when inspecting by eye.

Rank D: Vertical streak-like images were observed throughout the entire halftone image when inspecting by eye.

### 2-3. Contaminant Neutralization Performance

The performance of the plasma actuator 1 in neutralizing contaminants was measured as well.

The neutralization performance for contaminants (residual toner) on the plasma actuator was evaluated by measuring the amount of charge of the residual toner before and after the induced flow from the plasma actuator was supplied, using a charge distribution measurement apparatus as described below.

Specifically, using the electrophotographic image forming apparatus used in 2-2 above, the amount of residual toner was increased by increasing transfer current. Then, the charge distribution of the residual toner was measured after the induced flow was supplied by the plasma actuator driven under the same conditions as in 2-1 above. Then, aside from not driving the plasma actuator, the same operation was performed, and the charge distribution of the residual toner was measured again.

The transfer bias was adjusted and controlled such that the amount of residual toner when confirming the change in the charge polarity of the residual toner produced a fog value of 5% through the following measurement method. Specifically, the fog value was measured as follows. First, printing operations were stopped while a solid black image was being printed, and residual toner adhering between the transfer member contact region on the surface of the photosensitive drum and the charging member contact region was removed with tape (model CT18; manufactured by Nichiban Co., Ltd.). Next, the reflectance was measured using a reflectance densitometer (model TC-6DS/A, manufactured by Tokyo Denshoku Co., Ltd.), and the decrease in reflectance (%) based on the reflectance of the tape was measured and used as the fog value.

An E-spart analyzer (manufactured by Hosokawa Micron Corp.) was used to measure the charge distribution. The E-spart analyzer is an apparatus that introduces sample particles into a detection area (measurement area) where an electric field and an acoustic fields are generated simultaneously, measures the number-average particle diameter of the sample particles using the acoustic field, measures the movement speed of the sample particles using the laser Doppler method, and calculates the amount of charge of the sample particles.

The measurement was taken with an air flow rate of 400 L/min for the suction of the sample particles, a voltage of 100 V applied to the measurement area electrodes, and a count number of 300.

Then, taking the ratio of residual toner charged with the same polarity as the polarity applied to the transfer member when the plasma actuator is driven (polarity A) as X₁, and the ratio of residual toner charged with the same polarity as polarity A when the plasma actuator is not driven as X₂, the rate of change Δ in the percentage was calculated (Δ=((X₂−X₁)/X₂)×100).

In this example, a number ratio X of positively charged residual toner, among the charge distribution of the residual toner obtained by measurement, was calculated. The ratio of the number of positively charged residual toner particles to the total number of residual toner particles when the plasma actuator is driven was taken as X₁, the ratio of the number of positively charged residual toner particles to the total number of residual toner particles when the plasma actuator is not driven was set to X₂, and the rate of change Δ in the percentage (Δ=((X₂−X₁)/X₂)×100) was calculated.

In this example, X₁=8.1%, X₂=82.1%, and A=90.1%.

### 3. Durability Test

### 3-1. Contaminant Resistance

After evaluating the discharge stability as per 2-2 above, a total of 50,000 images were output continuously under the same conditions. The output image was assumed to be formed on A4-size paper with the letter “E” in 4-point font printed at a print percentage of 1.0%. Then, one halftone image (an image with horizontal lines 1 dot wide and 2 dots apart in the direction perpendicular to the direction of rotation of the photosensitive drum) was output. This halftone was observed by eye and under a microscope, and evaluated using the same criteria as for the vertical streaks in 2-2 above. In this example, the rank was rank A.

### 3-2. Contaminant Adhesion

After the contaminant resistance evaluation test in 3-1 above, the first electrode of the plasma actuator was observed along the longitudinal direction using a laser microscope (model Color 3D Laser Microscope VK-8700, manufactured by Keyence Corporation). A square field of view measuring 1000 μm vertically and 1000 μm horizontally was established on the area where contaminants (toner) adhered to the first electrode, and the number of toner particles adhering to the first electrode within the field of view was counted. The number of adhering contaminants were six.

In the examples in which streaks were confirmed in the contaminant resistance evaluation test in 3-1 above, the first electrode of the plasma actuator was observed by establishing the square field of view above an area corresponding to vertical streaks with the largest difference in density relative to the surrounding image.

### 3-3. Insulation Breakdown Evaluation

After the contaminant resistance evaluation test in 3-1 above, the first electrode of the plasma actuator was inspected by eye to confirm whether there were any locations where insulation breakdown had occurred between the first electrode and the second electrode, and the number of such locations was counted. In this example, no insulation breakdown occurred. If “burning” due to insulation breakdown was confirmed at the interface between the first electrode and the dielectric, or at the interface between the second electrode and the dielectric, it was determined that insulation breakdown had occurred. The number of cases of insulation breakdown is shown in Table 2.

### Examples 2 to 20

Plasma actuators 2 to 20 were prepared with the same configuration and arrangement, and through the same method as the plasma actuator 1, except that the conditions shown in Table 1 were changed. In addition, aside from using plasma actuators 2 to 20, the same process cartridge as that in Example 1 was prepared and evaluated. The evaluation results are shown in Table 2.

The dielectric in Example 19 was a polyimide resin sheet.

In Examples 7 to 10, an uneven shape was formed in the edge of the first electrode where discharge occurs, and the protruded portion was formed, by rubbing the cut aluminum foil with sandpaper.

### Example 21

In Example 21, silicone resin having different thicknesses at the leading end and trailing end (30 mm high, 300 mm wide, 150 μm thick at the leading end, and 3 mm thick at the trailing end) was prepared as illustrated in FIG. 9B. A plasma actuator 21 was prepared through the same method as the plasma actuator 1, with the exception of using the leading end of the prepared silicone resin as the dielectric.

The process cartridge was prepared and evaluated in the same manner as in Example 1, with the exception of the trailing end of the dielectric being attached to the process cartridge. The evaluation results are shown in Table 2.

### Example 22

A plasma actuator 22 was prepared with the same configuration and arrangement, and through the same method as the plasma actuator 1, except that the conditions shown in Table 1 were changed. Specifically, the first and second electrodes of the plasma actuator did not overlap, and were separated by a distance of 200 μm. In addition, aside from using the plasma actuators 22, the same process cartridge as that in Example 1 was prepared and evaluated. In this example, the two electrodes did not overlap, and thus the induced flow by the plasma actuator was weak, which is likely what resulted in a weaker neutralization and/or charging of the residual toner than in Example 1. This is thought to be the cause of image streaking after the durability testing. The evaluation results are shown in Table 2.

### Comparative Examples 1 to 3

Plasma actuators 23 to 25 were prepared with the same configuration and arrangement, and through the same method as the plasma actuator 1, except that the conditions shown in Table 1 were changed. In addition, aside from using the plasma actuators 23 to 25, the same process cartridge as that in Example 1 was prepared and evaluated. The evaluation results are shown in Table 2.

In Comparative Example 1, the induced flow was not supplied directly to the surface of the photosensitive drum, which resulted in poor performance in negatively charging the contaminants. Accordingly, it was not possible to suppress the adhesion of contaminants to the charging member, and vertical streaks appeared in the durability test. This is thought to be due to the fact that the two electrodes did not overlap and the induced flow generated was weak.

In Comparative Example 2, as in Comparative Example 1, the induced flow was not supplied directly to the surface of the photosensitive drum, and the adherence of contaminants could not be suppressed, resulting in vertical streaks appearing in the durability test.

In Comparative Example 3, no DC voltage was applied, and there was therefore no bias in the charge in the induced flow. Because the induced flow was electrically neutral, the surface of the photosensitive drum could not be charged, and image formation was not possible.

### Comparative Example 4

The same evaluations as in Example 1 were performed, aside from (1) the charging roller of the process cartridge was not removed, and a non-contact type charging roller was used as the charging member, without using a plasma actuator; (2) a POM roller having an outer diameter of 9.8 mm was attached to the core of the charging roller mounted in the process cartridge used, and the charging roller was separated from the photosensitive drum by a distance of 50 μm; and (3) the charging bias was set to −1500 V. The evaluation results are shown in Table 2.

In Comparative Example 4, a non-contact type charging roller was used, and no induced flow toward the drum surface was generated. Accordingly, it was not possible to suppress jumping of contaminants due to electrostatic attraction from the surface photosensitive drum surface to the charging roller, and contaminants continued to accumulate on the charging member, resulting in the occurrence of vertical streaks in the durability test.

### Comparative Example 5

The evaluation was performed in the same manner as in Example 1, with the exception of a scorotron charger being used as the charging member. As illustrated in FIG. 14, the scorotron charger includes a wire 1401, a casing 1402, and a grid 1403, and is disposed such that the grid is in close proximity to the photosensitive drum 104. Voltages were applied to the scorotron charger with the wire bias at 3 kVpp and the grid bias at −700 V. The evaluation results are shown in Table 2.

In Comparative Example 5, a scorotron charger was used, and thus no induced flow toward the drum surface was generated. Accordingly, it was not possible to suppress jumping of contaminants due to electrostatic attraction from the surface of the photosensitive drum to the charging member, and contaminants continued to accumulate on the charging member, resulting in the occurrence of vertical streaks in the durability test.

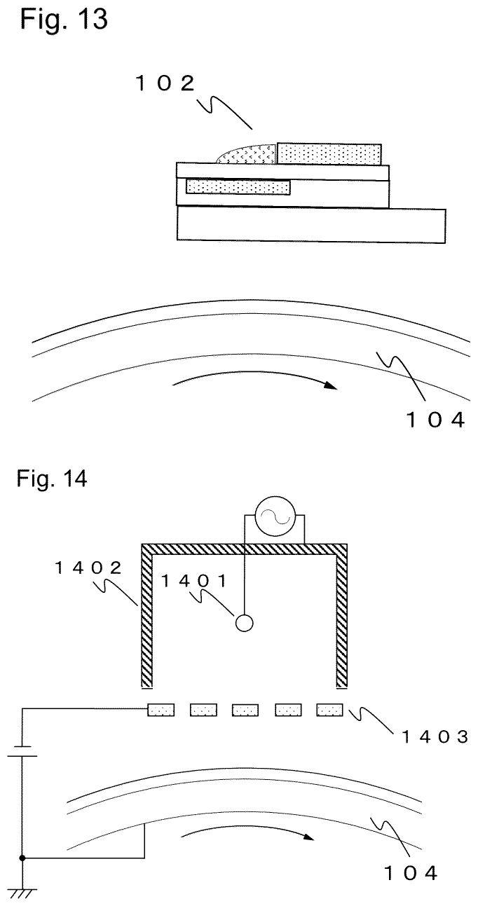

TABLE 1

| | Cross- | | | | | | | | | |
|---|---|---|---|---|---|---|---|---|---|---|
| | sectional | | | Protruded | Protruded | | | | | |
| | schematic | DC | Overlap | portion | portion | | Direction | Narrow | | |
| Example | view | voltage | length A | height | width | PA | of induced | angle θ | Dielectric | Base |
| No. | No. | (−V) | (μm) | (μm) | (μm) | position | flow | (°) | material | material |
| 1 | FIG. 7A | 600 | 500 | 20 | 22 | 1 | Counter | 30 | Silicone | ABS |
| 2 | FIG. 7A | 1000 | 500 | 21 | 22 | 1 | Counter | 30 | Silicone | ABS |
| 3 | FIG. 7A | 600 | 0 | 22 | 20 | 1 | Counter | 30 | Silicone | ABS |
| 4 | FIG. 7A | 600 | 100 | 21 | 20 | 1 | Counter | 30 | Silicone | ABS |
| 5 | FIG. 7A | 600 | 1000 | 21 | 21 | 1 | Counter | 30 | Silicone | ABS |
| 6 | FIG. 7A | 600 | 1200 | 19 | 20 | 1 | Counter | 30 | Silicone | ABS |
| 7 | FIG. 7A | 600 | 500 | 38 | 41 | 1 | Counter | 30 | Silicone | ABS |
| 8 | FIG. 7A | 600 | 500 | 40 | 95 | 1 | Counter | 30 | Silicone | ABS |
| 9 | FIG. 7A | 600 | 500 | 59 | 41 | 1 | Counter | 30 | Silicone | ABS |
| 10 | FIG. 7A | 600 | 1000 | 60 | 42 | 1 | Counter | 30 | Silicone | ABS |
| 11 | FIG. 7B | 600 | 500 | 21 | 21 | 2 | Counter | 30 | Silicone | ABS |
| 12 | FIG. 7D | 600 | 500 | 21 | 18 | 2 | With | 30 | Silicone | ABS |
| 13 | FIG. 7C | 600 | 500 | 22 | 20 | 1 | With | 30 | Silicone | ABS |
| 14 | FIG. 7A | 600 | 500 | 20 | 23 | 1 | — | 90 | Silicone | ABS |
| 15 | FIG. 7A | 600 | 500 | 20 | 20 | 1 | Counter | 45 | Silicone | ABS |
| 16 | FIG. 7A | 600 | 500 | 21 | 20 | 1 | Counter | 60 | Silicone | ABS |
| 17 | FIG. 7A | 600 | 500 | 22 | 22 | 1 | Counter | 80 | Silicone | ABS |
| 18 | FIG. 7A | 600 | 500 | 20 | 22 | 1 | Counter | 30 | Glass | ABS |
| 19 | FIG. 7A | 600 | 500 | 21 | 21 | 1 | Counter | 30 | Polyimide | ABS |
| 20 | FIG. 7A | 600 | 500 | 21 | 20 | 1 | Counter | 30 | Urethane | ABS |
| 21 | FIG. 7A | 600 | 500 | 20 | 19 | 1 | Counter | 30 | Silicone | Silicone |
| 22 | FIG. 7A | 600 | −200 | 25 | 20 | 2 | Counter | 30 | Silicone | ABS |
| C.E. 1 | FIG. 13 | 600 | −200 | 23 | 22 | 2 | Counter | — | Silicone | ABS |
| C.E. 2 | FIG. 13 | 600 | 500 | 22 | 21 | 1 | Counter | — | Silicone | ABS |
| C.E. 3 | FIG. 7A | 0 | 500 | 20 | 20 | 1 | Counter | 30 | Silicone | ABS |
| C.E. 4 | — | — | — | — | — | — | — | — | — | — |
| C.E. 5 | FIG. 14 | — | — | — | — | — | — | — | — | — |

In the table, in the column for overlap length A, −200 μm indicates that the first electrode and the second electrode do not overlap and are separated by a distance of 200 μm. In the PA position column, 1 indicates that the base material is disposed between the first electrode and the electrophotographic photosensitive member, and 2 indicates that the plasma actuator is disposed between the base material and the electrophotographic photosensitive member. In the table, C.E. indicates Comparative Example.

TABLE 2

| | | | Contaminant neutralization | | | | | |
|---|---|---|---|---|---|---|---|---|
| | | Discharge | performance | | | | | |
| | Discharge | induced flow | | | Rate of | | | Insulation |
| Example | stability | velocity | X₁ | X₂ | change Δ | Contaminant | Contaminant | breakdown |
| No. | evaluation | (m/sec) | (%) | (%) | (%) | resistance | adherence | evaluation |
| 1 | A | 0.29 | 8.1 | 82.1 | 90.1 | A | 6 | 0 |
| 2 | A | 0.32 | 4.3 | 81.3 | 94.7 | A | 3 | 0 |
| 3 | A | 0.23 | 26.5 | 82.2 | 67.8 | B | 23 | 0 |
| 4 | A | 0.26 | 15.5 | 84.1 | 81.6 | A | 11 | 0 |
| 5 | A | 0.24 | 20.1 | 83.1 | 75.8 | A | 13 | 0 |
| 6 | A | 0.14 | 45.6 | 82.4 | 44.7 | B | 37 | 0 |
| 7 | A | 0.29 | 9.3 | 81.9 | 88.6 | A | 7 | 0 |
| 8 | B | 0.29 | 8.2 | 81.7 | 90.0 | B | 6 | 0 |
| 9 | C | 0.29 | 8.7 | 81.0 | 89.3 | C | 6 | 0 |
| 10 | B | 0.30 | 7.4 | 80.5 | 90.8 | B | 11 | 0 |
| 11 | A | 0.29 | 8.3 | 82.1 | 89.9 | B | 26 | 0 |
| 12 | A | 0.28 | 13.5 | 84.1 | 83.9 | B | 30 | 0 |
| 13 | A | 0.28 | 17.3 | 83.6 | 79.3 | B | 21 | 0 |
| 14 | A | 0.29 | 21.1 | 83.5 | 74.7 | B | 24 | 0 |
| 15 | A | 0.29 | 7.1 | 81.2 | 91.3 | A | 12 | 0 |
| 16 | A | 0.27 | 16.2 | 80.0 | 79.8 | B | 21 | 0 |
| 17 | A | 0.28 | 21.3 | 80.9 | 73.7 | B | 26 | 0 |
| 18 | A | 0.29 | 8.4 | 80.1 | 89.5 | A | 10 | 0 |
| 19 | A | 0.29 | 8.1 | 83.1 | 90.3 | A | 11 | 0 |
| 20 | A | 0.25 | 14.7 | 83.4 | 82.4 | B | 15 | 0 |
| 21 | A | 0.29 | 8.7 | 83.8 | 89.6 | A | 6 | 0 |
| 22 | A | 0.08 | 52.1 | 81.8 | 36.3 | C | 79 | 0 |
| C.E. 1 | A | 0.07 | 68.9 | 80.5 | 14.4 | D | 181 | 0 |
| C.E. 2 | A | 0.28 | 67.4 | 84.1 | 19.9 | D | 117 | 0 |
| C.E. 3 | — | 0.27 | 83.3 | 83.9 | 0.7 | — | — | — |
| C.E. 4 | A | — | 17.4 | 82.2 | 78.8 | D | 153 | 0 |
| C.E. 5 | A | — | 20.1 | 83.1 | 75.8 | D | 123 | 0 |

In the table, C.E. indicates Comparative Example.

According to at least one aspect of the present disclosure, a charging apparatus capable of stably charging a body to be charged over a long period of time can be obtained. Additionally, according to at least one aspect of the present disclosure, a process cartridge that contributes to high-quality electrophotographic image formation over a long period of time can be obtained. Furthermore, according to at least one aspect of the present disclosure, an electrophotographic image forming apparatus capable of forming high-quality electrophotographic images over a long period of time can be obtained.

While the present disclosure has been described with reference to embodiments. it is to be understood that the present disclosure is not limited to the disclosed embodiments. The scope of the following claims is to be accorded the broadest interpretation so as to encompass all such modifications and equivalent structures and functions.

What is claimed is:

1. A charging apparatus for charging a body to be charged, the charging apparatus comprising:
a plasma actuator,
wherein the plasma actuator comprises:
a dielectric;
a first electrode provided on a first surface of the dielectric; and
a second electrode disposed with the dielectric interposed between the first electrode and the second electrode,
wherein when an AC voltage is applied between the first electrode and the second electrode, the plasma actuator generates an induced flow from an edge of the first electrode along an exposed portion of the first surface of the dielectric which is not covered by the first electrode,
the plasma actuator is disposed such that the induced flow is directly supplied to the surface of the body to be charged, and
a DC voltage is applied between the first electrode and the body to be charged.

2. The charging apparatus according to claim 1,
wherein the first electrode and the second electrode are disposed obliquely with a shift across the dielectric.

3. The charging apparatus according to claim 1,
wherein when the plasma actuator is viewed in perspective from the first surface side, an overlapping portion where at least a portion of the first electrode and the second electrode overlap is present, and
a length A between an edge of the first electrode and an edge of the second electrode forming the overlapping portion is 0 to 1000 μm.

4. The charging apparatus according to claim 1,
wherein a height of a protruded portion at an edge of the first electrode is not more than 40 μm.

5. The charging apparatus according to claim 1, further comprising:
a base material,
wherein the plasma actuator is disposed on a surface of the base material, and
the base material is disposed between the plasma actuator and the body to be charged.

6. The charging apparatus according to claim 1, further comprising:
a base material,
wherein the plasma actuator is disposed on a surface of the base material, and
the plasma actuator is disposed between the base material and the body to be charged.

7. The charging apparatus according to claim 1,
wherein the body to be charged is an electrophotographic photosensitive member,
when a point where an extension line extending from an edge of the first electrode in a direction along the exposed portion of the first surface of the dielectric intersects a surface of the electrophotographic photosensitive member is taken, a velocity vector in a direction of rotation of the electrophotographic photosensitive member on a tangent relative to the surface of the electrophotographic photosensitive member at the point is taken as a tangent vector, and
when a flow direction vector of the induced flow supplied from the plasma actuator is decomposed, the flow direction vector has a direction component which is parallel to the tangent vector and facing the same direction as the tangent vector.

8. The charging apparatus according to claim 1,
wherein the body to be charged is an electrophotographic photosensitive member,
when a point where an extension line extending from an edge of the first electrode in a direction along the exposed portion of the first surface of the dielectric intersects a surface of the electrophotographic photosensitive member is taken, a velocity vector in a direction of rotation of the electrophotographic photosensitive member on a tangent relative to the surface of the electrophotographic photosensitive member at the point is taken as a tangent vector, and
when a flow direction vector of the induced flow supplied from the plasma actuator is decomposed, the flow direction vector has a direction component which is parallel to the tangent vector and facing an opposite direction from the tangent vector.

9. The charging apparatus according to claim 1,
wherein the body to be charged is an electrophotographic photosensitive member,
when a point where an extension line extending from an edge of the first electrode in a direction along the exposed portion of the first surface of the dielectric intersects a surface of the electrophotographic photosensitive member is taken, a velocity vector in a direction of rotation of the electrophotographic photosensitive member on a tangent relative to the surface of the electrophotographic photosensitive member at the point is taken as a tangent vector, and
when a narrow angle formed between the extension line extending from the edge of the first electrode in the direction along the exposed portion of the first surface of the dielectric and the tangent vector is defined as a narrow angle θ, the narrow angle θ is 0° to 90°.

10. The charging apparatus according to claim 9,
wherein the narrow angle θ is 10° to 45°.

11. The charging apparatus according to claim 1, further comprising:
a base material,
wherein the dielectric of the plasma actuator is the base material.

12. The charging apparatus according to claim 1,
wherein the dielectric is a silicone resin.

13. A process cartridge capable of being attached to and removed from a body of an electrophotographic image forming apparatus, the process cartridge comprising the charging apparatus according to claim 1.

14. An electrophotographic image forming apparatus comprising a charging apparatus, the charging apparatus comprising:
a plasma actuator,
wherein the plasma actuator comprises:
a dielectric;
a first electrode provided on a first surface of the dielectric; and
a second electrode disposed with the dielectric interposed between the first electrode and the second electrode,
wherein when an AC voltage is applied between the first electrode and the second electrode, the plasma actuator generates an induced flow from an edge of the first electrode along an exposed portion of the first surface of the dielectric which is not covered by the first electrode,
the plasma actuator is disposed such that the induced flow is directly supplied to the surface of the body to be charged, and
a DC voltage is applied between the first electrode and the body to be charged.
